(19) United States
(12) Patent Application Publication
(10) Pub. No.: US 2018/0169942 A1
(43) Pub. Date: Jun. 21, 2018

(54) APPARATUS AND METHOD FOR RELEASE OF ADDITIVELY MANUFACTURED PRODUCTS AND BUILD PLATFORM

(71) Applicant: AddiFab ApS, Jyllinge (DK)

(72) Inventors: Jon JESSEN, Veksø (DK); Lasse Guldborg STAAL, Jyllinge (DK)

(21) Appl. No.: 15/574,943

(22) PCT Filed: May 19, 2016
(86) PCT No.: PCT/EP2016/061347

§ 371 Date: Nov. 17, 2017

(30) Foreign Application Priority Data
May 19, 2015 (DK) PA201570294

(51) Int. Cl. B29C 64/245; B33Y 10/00; B33Y 30/00; B29C 64/129; B29C 64/264; B29C 64/255

(52) U.S. Cl. CPC B29C 64/245; B33Y 10/00; B29C 64/255; B29C 64/129; B29C 64/264; B33Y 30/00

(57) ABSTRACT

An additive manufacturing apparatus for manufacturing a product. The apparatus includes a container for holding a radiation-curable liquid, a build platform having a build surface for holding a product being manufactured during a manufacturing process, a radiation source for providing hardening radiation to selectively solidify radiation-curable liquid in the container by exposure to form the product. The build platform is movable relative to the container in a predetermined direction. The apparatus further includes a temperature element that is integrated in the building platform with the purpose of generating or removing heat from the build surface and/or the product, and a controller for causing the temperature element to generate or remove heat from the build surface and/or the product until the product releases from the build surface. A corresponding method, and a build platform are also provided.

### TECHNICAL FIELD The present invention relates to additive manufacturing.

### BACKGROUND OF THE INVENTION

Additive manufacturing—also called 3D printing—has become an important product development tool. Rapid prototyping, iterative design and concept validation are three disciplines that are considerably facilitated by 3D printers. Several different 3D printing platforms are commercially available in the market today, and each of these platforms have important characteristics and advantages that a product developer may exploit to create design models, demonstrators, functional prototypes, and small batches of components for product validation. However, currently available 3D printers share an important set of limitations that are preventing use of 3D printing technologies in mass manufacturing of components.

When a product is additively formed on a build surface of a build platform of a 3D printer, it is essentially glued to the build surface. Presently, removal is typically done by means of manual disruption of adhesion by way of breaking or sawing, which may result in deformation or destruction of the product (for manual breaking) or may require that additional material be set aside to provide a sawable area (for sawing). For bottom-projection systems, a frequently employed manufacturing technique is to include in the manufacturing of the component, the manufacturing of a component base plate with a large surface area, which will then have to be broken away from the build surface by a correspondingly large force. Neither sawing nor manual breaking away allow for high yield. They are relatively time consuming and they involve a risk of stressing, straining, and/or otherwise deforming the products to be removed.

Attempts have been made at resolving the problem of product adherence. Patent specification EP 2 199 068 A2 discloses an additive manufacturing apparatus comprising a printing tray that is configured to receive one or more printed objects. Said one or more objects may adhere to the printing platform as part of a 3D-printing process and

EP 2 199 068 A2 discloses methods for exploiting a difference in thermal expansion between the printing tray and the products to break this adherence and separate the products from the tray. The disclosed methods involve exposing the printing tray to an external source of low temperature (cold water and/or cold air) to generate this difference in thermal expansion.

The use of cold water carries with it a number of drawbacks. A drawback is that a lowest temperature threshold of cold water is above zero degrees Celsius and therefore that the lowest temperature that may be achieved in the tray thus also will be above zero degrees. This limits the difference in temperature that may be achieved between the tray and the products.

Another drawback is the thermal capacity of water, which imposes a constraint on the amount of heat that can be removed from the printing tray and thus the speed of cooling.

A further drawback is that the use of water in or connected to an additive manufacturing apparatus significantly complicates cleaning and maintenance of said additive manufacturing apparatus. Leakages, oxidation, and promoted growth of bacteria are just three of a wider range of complications that may arise as a result of usage of water as a coolant.

An additional drawback is that the foot-print of the additive manufacturing apparatus grows significantly when sources of cold water (or cold air) need to be involved, which may result in increased costs-of-operation through the need for additional floor-space.

In addition to increased foot-print, the usefulness of cold air is reduced by the fact that the thermal capacity of air is less than the thermal capacity of water. Cooling speed is thus slower when cold air is used as coolant compared to using water.

As demonstrated above, the principle of using an external source of energy, such as cold water or air, to generate a difference in thermal expansion between products and a printing tray involve a number of limitations. An improved system is therefore desirable for the creation of a difference in thermal expansion between products and a printing tray.

### SUMMARY OF THE INVENTION

The present invention addresses the issues described above, at least to an extent.

A first aspect of the invention provides an additive manufacturing apparatus for manufacturing a product. The apparatus comprises:
a container (also equally referred to as a vat in the following) for holding a radiation-curable liquid,
a build platform having a build surface for holding a product being manufactured during a manufacturing process, the build platform being movable relative to the container in a predetermined direction,
a radiation source for providing hardening radiation to selectively solidify radiation-curable liquid in the container by exposure to form the product, and the additive manufacturing apparatus is characterized in that it further comprises:
at least one temperature element being integrated in the build platform and being adapted to generate and/or remove heat from the build surface and/or the product,
a controller for causing the at least one temperature element to generate and/or remove an amount of heat from the build surface and/or the product, the amount of heat being at least sufficient for causing the product to release from the build surface due to tension induced due to a difference in a thermal expansion property of the build surface and a thermal expansion property of the product.

It is to be understood that the at least one integrated temperature element is adapted to actively generate and/or actively remove heat from the build surface and/or the product.

In some embodiments, the one or more integrated temperature elements are energized to generate heat in and/or remove heat from the build surface by applying an electric voltage to the one or more temperature elements.

The at least one temperature element may be adapted to both generate and remove heat, but generally not at the same time.

In some embodiments, heat is generated or removed from the build surface and/or the product until the product releases from the build surface.

Heat can also be thought of as thermal energy. Generating/removing heat corresponds to generating/removing thermal energy.

Due to a difference between the thermal expansion coefficient of the product and the build surface (the coefficients are never entirely identical), the product will at some point release from the build surface. The method is very effective and rarely destructive if implemented properly.

In some embodiments, the at least one temperature element is configured to remove heat from the build surface during a cooling period and to generate heat in the build surface during a heating period.

In some embodiments, the at least one temperature element is configured to remove heat from the product during a cooling period and to generate heat in the product during a heating period.

In some embodiments, the at least one temperature element comprises one or more resistive elements that produce heat when a voltage is applied across them.

In some embodiments, the at least one temperature element comprises one or more thermoelectric elements, such as one or more Peltier elements and/or one or more microwave elements and/or one or more inductive elements, configured to remove and/or generate heat in the build surface and/or the product(s) during a respective cooling and/or heating period. In some embodiments, the one or more thermoelectric elements is/are adapted to remove heat from the build surface so that build surface reaches temperatures that may be −25 degrees Celsius or less or alternatively to generate heat in the build surface so that it reaches temperatures that may be 125 degrees Celsius or more.

In some embodiments, the controller causes the at least one temperature element to generate or remove heat from the build surface and/or the product at least for a period after completion of the addictive manufacturing of the product.

In some embodiments, addition or removal of heat happens while the build plane is within the additive manufacturing apparatus while other in other embodiments, the addition or removal of heat may take place outside the additive manufacturing apparatus. A particular set of embodiments comprise addition or removal of heat at a product removal station.

Some embodiments comprise a release sensor for detecting that the product has been released. A weight sensor, vibration sensor, electronic visual identification are examples of ways to implement a release sensor.

In some embodiments, the build surface comprises at least two temperate elements adapted to remove heat at one part of the build surface and to generate heat at another different part of the build surface.

In some embodiments, the controller causes the at least one temperature element to generate or remove heat from the build surface and/or the product until the build surface and/or product reaches a predetermined target temperature. A temperature sensor, such as a contact thermometer or infrared radiation thermometer, may be used to determine a current temperature reading. A temperature reading is fed to the controller, which then controls the at least one temperature element as required.

In some embodiments, the build platform further comprises one or more air jet vents for supporting efficient release of one or more products, the one or more air jet vents being adapted to receive compressed air or gas from an integrated and/or external source.

In some embodiments, one or more mechanical elements or devices (that may be internal and/or external to additive manufacturing apparatus) is used to supplement the thermal release as described above, e.g. by aiding the actual release and/or controlling the release of one or more products. In some embodiments, the one or more mechanical elements or devices applies mechanical force to a side of one or more objects to be released and (gently) pushes or nudges the object(s) to be released. In some embodiments, the one or more objects to be released each comprises a cavity or the like to receive at least a part of the one or more mechanical elements or devices applying the mechanical release force. The cavity can be formed during the additive manufacture of the product or alternatively be located in a support structure. Each cavity preferably has an opening in a direction pointing towards the build surface to facilitate being lifted or pushed away from the build surface when a cavity receives at least a part of the one or more mechanical elements or devices. In some embodiments, the cavity is a fillet or chamfer and the one or more mechanical elements or devices (that applies mechanical force to a side of the one or more objects to be released) is a relatively thin hard object; at least where it is to engage with the fillet or chamfer.

More specifically, in some embodiments, one or more products each comprises a cavity in the form of a chamfer or fillet, the cavity having an opening in a direction towards the build surface, and wherein the cavity is adapted to receive at least a part of one or more internal or external mechanical elements or devices adapted to apply a lateral force to the one or more products in their respective cavity thereby aiding the release of the one or more products.

A second aspect of the invention provides a method for additive manufacturing of a product. The method comprises:
manufacturing the product during an additive manufacturing process, the product being formed by additive manufacturing on a build surface of an additive manufacturing apparatus,
   wherein the method further comprises:
adding or removing an amount of heat from the build surface and/or the product by at least one temperature element integrated in the build surface, the amount of heat being sufficient for causing the product to release from the build surface due to tension induced due to a difference in a thermal expansion property of the build surface and a thermal expansion property of the product.

In some embodiments, heat is added or removed from the build surface and/or the product until the product releases from the build surface.

Embodiments of the invention can be used with various types of additive manufacturing apparatuses, including top-projection and bottom-projection types.

A third aspect of the invention provides a build platform as described above and more specifically a build platform specifically for an additive manufacturing apparatus, e.g. according to any one or claims 1-9, for manufacturing a product, the build platform comprising a build surface and at least one temperature element being adapted to generate and/or remove heat from the build surface and/or the product, wherein the at least one temperature element is integrated in the build platform.

Embodiments of the build platform comprise: a build surface; a controller for causing the at least one temperature element to generate or remove heat from the build surface and/or a product until the product manufactured on the build surface releases from the build surface.

### BRIEF DESCRIPTIONS OF THE DRAWINGS

FIG. 1 illustrates a bottom-projection type additive manufacturing apparatus.

FIGS. 2, 3 and 4 illustrate a build platform in accordance with embodiments of the invention.

### DETAILED DESCRIPTION OF SELECTED EMBODIMENTS

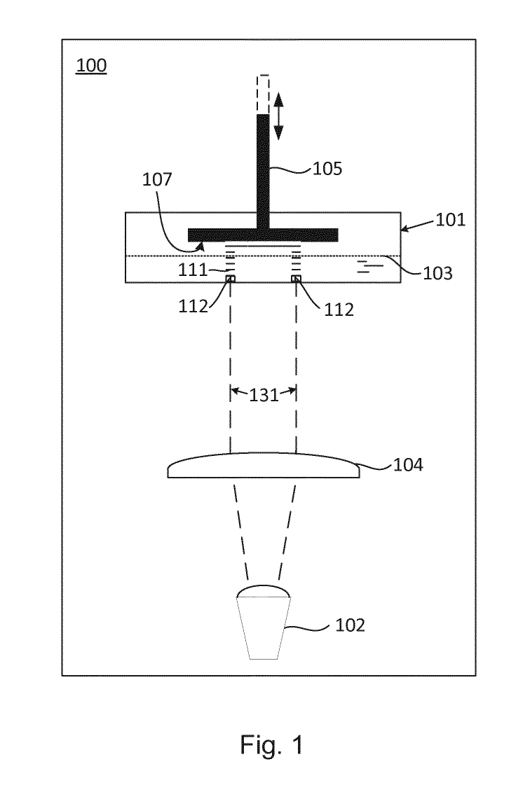

FIG. 1 illustrates generically a bottom-projection type of additive manufacturing apparatus 100. It comprises a vat 101 or other suitable container for holding a radiation-curable liquid 103 (indicated by its surface); a movable platform 105 having a build surface 107 that can be moved relative to the vat; and a radiation source 102 for providing hardening radiation 131 for selectively solidifying radiation-curable liquid in the vat. A lens system 104 focuses the radiation onto the radiation-curable liquid. The radiation source can provide radiation in a pattern corresponding to a layer to be formed. Element 111 illustrates already formed layers. Element 112 illustrates a newly formed layer, the shape of which is defined by the pattern provided by the radiation source. The radiation-curable liquid 103 and layers 111 and 112 are not part of the apparatus but are included to illustrate how a product is manufactured during an additive manufacturing process.

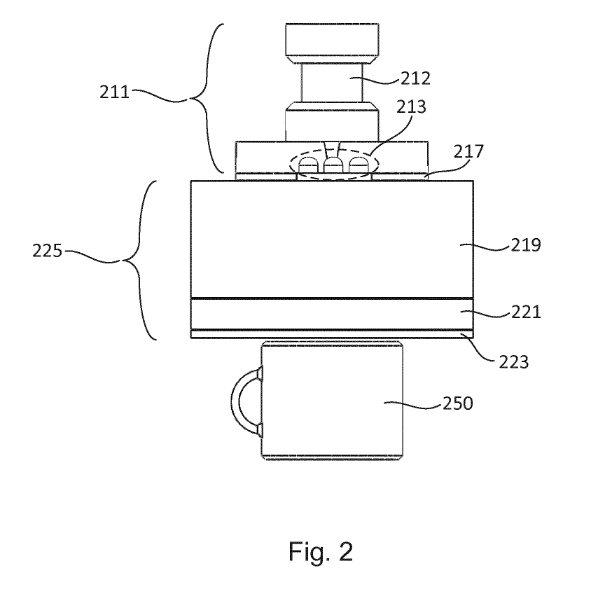

FIG. 2 illustrates a build platform 225 with a build surface 223 corresponding to element 105 and 107, respectively, in FIG. 1. The build platform, in this exemplary case, comprises a standard carrier, having an attachment section 212 for attaching the carrier to moving elements to enable moving the build surface relative to the vat before, during, and/or after a manufacturing process. Terminals 213 are included to allow connection to a power source. In this embodiment, there are three terminals (phase or DC and, optionally, protective earth). The terminal provides power to at least one active temperature element, which in this case is one or more Peltier elements 221 but may also be one or more microwave elements, inductive elements, resistive elements, and/or other sources of thermoelectric energy. At least one thermal sensor (not shown) may be also integrated in the build platform to allow monitoring of at least a first temperature. In some embodiments, at least one thermal sensor is external to the build platform. A heat sink insulator 217 is optionally included to reduce the transfer of heat between the carrier 211 and a heat sink 219. The heat sink 219 may alternatively be external to the build platform 225. Next to the heat sink 219 is at least one temperature element, which in this case is a Peltier element 221, being integrated in the build surface 223 so that build surface 223 can be cooled or heated by generating or removing heat by the Peltier element/the at least one temperature element 221. The product is formed on the build surface. FIG. 2 illustrates a cup 250 that has been manufactured on the build surface by additive manufacturing.

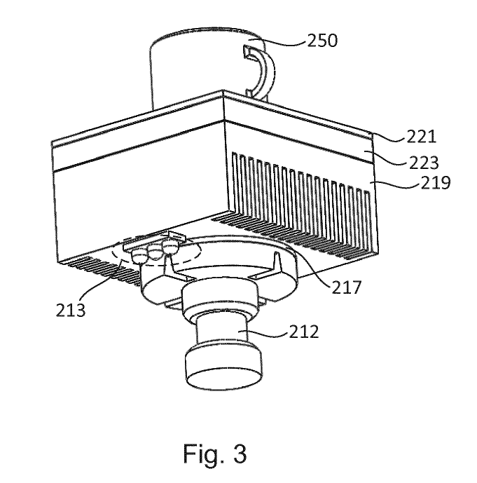

FIG. 3 is another view of the part shown in FIG. 2.

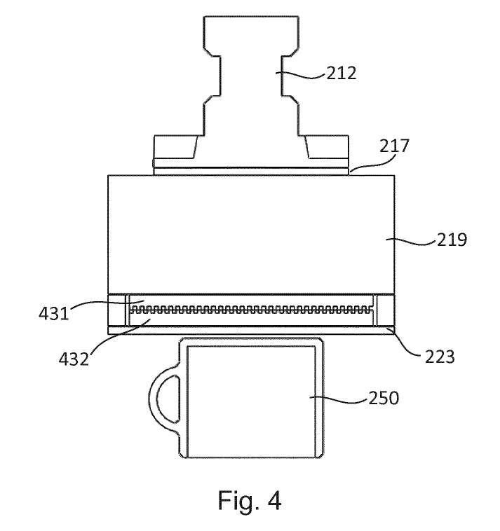

FIG. 4 illustrates a cross section of the view in FIG. 2, revealing the integrated Peltier element schematically. The Peltier element has two sides 431, 432. Depending on the voltage added on the terminals (see e.g. 213 in FIG. 2), the Peltier element will either remove or generate heat in the build surface. By reversing the voltage, the Peltier element will generate or remove heat, respectively, (i.e. the opposite) in the build surface.

When the build surface is actively heated or actively cooled relative to the manufactured product by one or more temperature elements being integrated in the build surface, there is a difference in the respective expansion or contraction between the build surface and the product. Many types of photo-curable liquids expand less with temperature than metals. Thus, if the product is formed on a metal build surface, and the build surface is cooled, the product will contract less than the metal. The result is that when the temperature has changed sufficiently, the product can no longer adhere to the build surface and is instead released. This provides a much more controlled and reproducible release than prior art methods.

It is the difference in thermal expansion coefficient between the build surface and the product, respectively, that determines how much the build surface must be heated or cooled for the product to be released.

Some embodiments, that are particularly well suited for high-volume applications, comprise a heating element that supports return of the build surface to a desired production or target temperature with as small a delay as possible. In some embodiments, the Peltier element itself is used for both cooling and heating the build surface (by reversing the applied voltage, possibly using a different voltage amplitude). Other embodiments employ at least one separate temperature element in addition to the Peltier element described above.

Some embodiments comprise a thermal sensor element that allows for controlling the build surface temperature, for instance to reach a certain build surface temperature during the release process or to obtain a certain temperature in preparation for production of another product.

Some embodiments support the circulation of cooled or heated fluid (e.g. gas or liquid or mix thereof). Some embodiments comprise a cooler or heater unit that may remove or generate heat when the product and/or build surface is brought into contact with said fluid. For instance, the product and build surface may be cooled or heated to the same temperature different from the manufacturing temperature.

The difference in thermal expansion coefficients of the build surface and product will cause the product to be released from the build surface if the temperature change from the manufacturing temperature is sufficient, for instance at least 10 degrees Celsius or at least 20 degrees Celsius or at least 30 degrees Celsius, depending on the materials involved.

In some embodiments, the build surface has heat removed at one part, e.g. at one half, and heat generated at another part, e.g. at the other half, e.g. using at least two temperature elements both integrated in the build surface. The resulting thermal difference at the build surface (preferably at or at least near where one or more products are fixed to the build surface) may further facilitate release of a product from the build surface.

In some embodiments, the product is being held by a robotic grabber or other suitable element during and after the release procedure. Alternatively, the build platform may controllably be turned to a position in which the product is on a top side of the build surface and is held in place by gravity when the product is released. Other means that may be used to retain a component in position on a carrier plate following release include air jets and vacuum. Air jet vents that may receive compressed air from an integrated and/or external source may also be provided in the build platform for supporting efficient release of products.

1. An additive manufacturing apparatus for manufacturing a product comprising:
a container for holding a radiation-curable liquid,
a build platform having a build surface for holding a product being manufactured during a manufacturing process, the build platform being movable relative to the container in a predetermined direction,
a radiation source for providing hardening radiation to selectively solidify radiation-curable liquid in the container by exposure to form the product,
at least one temperature element being integrated in the build platform and being adapted to generate and/or remove heat from the build surface and/or the product,
a controller configured to cause the at least one temperature element to generate or remove an amount of heat from the build surface or from the product, the amount of heat at least being sufficient for causing the product to release from the build surface due to tension induced due to a difference in a thermal expansion property of the build surface and a thermal expansion property of the product.

2. An additive manufacturing apparatus in accordance with claim 1, wherein the at least one temperature element is configured to remove heat from the build surface during a cooling period and to generate heat in the build surface during a heating period.

3. An additive manufacturing apparatus in accordance with claim 1, wherein the at least one temperature element is configured to remove heat from the product during a cooling period and to generate heat in the product during a heating period.

4. An additive manufacturing apparatus in accordance with claim 1, wherein the at least one temperature element comprises one or more Peltier elements, microwave elements, inductive elements, or similar thermoelectric elements configured to remove or generate heat in the build surface during a respective cooling or heating period.

5. An additive manufacturing apparatus in accordance with claim 1, wherein the at least one temperature element comprises one or more resistive elements that produce heat when a voltage is applied across them.

6. An additive manufacturing apparatus in accordance with claim 1, wherein the controller causes the at least one temperature element to generate or remove heat from the build surface or the product at least for a period after completion of the addictive manufacturing of the product.

7. An additive manufacturing apparatus in accordance with claim 1, wherein the controller causes the at least one temperature element to generate or remove heat from the build surface or the product until the build surface or product reaches a predetermined target temperature.

8. An additive manufacturing apparatus in accordance with claim 1, wherein the build surface comprises at least two temperate elements adapted to remove heat at one part of the build surface and to generate heat at another different part of the build surface.

9. An additive manufacturing apparatus in accordance with claim 1, wherein the build platform further comprises one or more air jet vents for supporting efficient release of one or more products, the one or more air jet vents being adapted to receive compressed air or gas from an integrated or external source.

10. An additive manufacturing apparatus in accordance with claim 1, wherein one or more products each comprises a cavity in the form of a chamfer or fillet, the cavity having an opening in a direction towards the build surface, and wherein the cavity is adapted to receive at least a part of one or more internal or external mechanical elements or devices adapted to apply a lateral force to the one or more products in their respective cavity thereby aiding the release of the one or more products.

11. A method for additive manufacturing of a product, comprising:
manufacturing the product by an additive manufacturing process, the product being formed by additive manufacturing on a build surface of an additive manufacturing apparatus,
characterized in that the method further comprises:
generating and/or removing an amount of heat from the build surface and/or the product by at least one temperature element being integrated in the build platform, the amount of heat at least being sufficient for causing the product to release from the build surface due to tension induced due to a difference in a thermal expansion property of the build surface and a thermal expansion property of the product.

12. A build platform specifically for an additive manufacturing apparatus, according to claim 1, for manufacturing a product, the build platform comprising a build surface and at least one temperature element being adapted to generate and/or remove heat from the build surface and/or the product, wherein the at least one temperature element is integrated in the build platform.

13. An additive manufacturing apparatus in accordance with claim 2, wherein the at least one temperature element is configured to remove heat from the product during a cooling period and to generate heat in the product during a heating period.

14. An additive manufacturing apparatus in accordance with claim 2, wherein the at least one temperature element comprises one or more Peltier elements, microwave elements, inductive elements, or similar thermoelectric elements configured to remove or generate heat in the build surface during a respective cooling or heating period.

15. An additive manufacturing apparatus in accordance with claim 3, wherein the at least one temperature element comprises one or more Peltier elements, microwave elements, inductive elements, or similar thermoelectric elements configured to remove or generate heat in the build surface during a respective cooling or heating period.

16. An additive manufacturing apparatus in accordance with claim 2, wherein the controller causes the at least one temperature element to generate or remove heat from the build surface or the product at least for a period after completion of the addictive manufacturing of the product.

17. An additive manufacturing apparatus in accordance with claim 3, wherein the controller causes the at least one temperature element to generate or remove heat from the build surface or the product at least for a period after completion of the addictive manufacturing of the product.

18. An additive manufacturing apparatus in accordance with claim 2, wherein one or more products each comprises a cavity in the form of a chamfer or fillet, the cavity having an opening in a direction towards the build surface, and wherein the cavity is adapted to receive at least a part of one or more internal or external mechanical elements or devices adapted to apply a lateral force to the one or more products in their respective cavity thereby aiding the release of the one or more products.

19. An additive manufacturing apparatus in accordance with claim 3, wherein one or more products each comprises a cavity in the form of a chamfer or fillet, the cavity having an opening in a direction towards the build surface, and wherein the cavity is adapted to receive at least a part of one or more internal or external mechanical elements or devices adapted to apply a lateral force to the one or more products in their respective cavity thereby aiding the release of the one or more products.

20. An additive manufacturing apparatus in accordance with claim 7, wherein one or more products each comprises a cavity in the form of a chamfer or fillet, the cavity having an opening in a direction towards the build surface, and wherein the cavity is adapted to receive at least a part of one or more internal or external mechanical elements or devices adapted to apply a lateral force to the one or more products in their respective cavity thereby aiding the release of the one or more products.
